(19) United States
(12) Patent Application Publication
(10) Pub. No.: US 2009/0120252 A1
(43) Pub. Date: May 14, 2009

(54) DIVIDER INSERT FEED SYSTEM

(76) Inventors: Doug Petrovich, New Carlisk, IN (US); Matt Williamson, St. Joseph, MI (US); Randy Bird, Fennville, MI (US); Lester Page, JR., Stevensville, MI (US)

Correspondence Address: ROBERT J. SAYFIE, P.C., 161 OTTAWA AVENUE NW, SUITE 407, GRAND RAPIDS, MI, 49503, US

(21) Appl. No.: 11/938,774

(22) Filed: Nov. 12, 2007

(51) Int. Cl. B26D 3/00; B65H 20/02

(52) U.S. Cl. 83/53; 83/156

(57) ABSTRACT

A divider insert feed system, comprising: a drive roller (50) capable of displacing paper; at least one of an upper shear blade (100) or a lower shear blade (90) that is positioned downstream of the drive roller (50). The upper shear blade (100) and the lower shear blade (90) capable of cutting a length of paper to form a divider insert (230). An air knife (120) that is capable of displacing the divider insert (230) to a cutting position (500); a slicing blade (20) disposed upwardly from the divider insert (230). The slicing blade (20) capable of descending and pushing the divider insert (230) downwardly to position the divider insert (230) into position into a workpiece.

### BACKGROUND OF THE INVENTION

This invention relates to an apparatus, system and method of displacing paper from a paper roll to a desired length piece of paper called a divider insert, then positioning the divider insert into position.

This invention is capable of cutting the paper to form the divider insert, and then displacing the cut paper or divider insert by means of an air knife to a location under a blade and above an adjustable opening. The blade then descends, pushing the paper through the adjustable or cam controlled opening, and folding the cut paper, also called a divider insert. The descending blade then positions the divider insert between adjacent portions of a food product.

U.S. Pat. No. 4,299,148 issued in 1981 to Meier shows the method of cutting a food item in which a sheet of wax paper is folded about the cutting edge of a guillotine blade before the blade is forced into the food item. The sheet of wax paper then remains as a separator.

U.S. Pat. No. 5,138,823 issued in 1992 to Hartman et al. shows a complex machine for introducing foil-like material between slices of a food product that has, apparently, already been cut by a cutting machine. U.S. Pat. No. 4,565,053 issued Jan. 21, 1986 to Browne and Hertzberg discloses an apparatus for cutting round pastries, such as cake, and then after cutting inserting a divider between each two adjacent portions.

U.S. Pat. No. 5,862,728 issued in 1999 to Giamello shows an apparatus for cutting food products in which a cutting blade energized with ultrasonic vibrations is driven through different layers of a food product at a controlled and variable speed.

As can be seen, there is a need for am apparatus, system and method that can quickly cut paper from a roll, using less mechanical parts then in the existing art. There is also a need to be able to quickly and easily adjust the desired length of the paper to be inserted. There is also a need for a divider insert feed system that does not cause the divider inserts to curl up, curl down, or jam.

### SUMMARY OF THE INVENTION

One aspect of the present invention is A divider insert feed system, comprising: a drive roller (50) capable of displacing paper; at least one of an upper shear blade (100) or a lower shear blade (90) that is positioned downstream of said drive roller (50), said upper shear blade (100) and said lower shear blade (90) capable of cutting a length of paper to form a divider insert (230); an air knife (120) that is capable of displacing the divider insert (230) to a cutting position (500); a slicing blade (20) disposed upwardly from said divider insert (230), said slicing blade (20) capable of descending and pushing said divider insert (230) downwardly to position said divider insert (230) into position into a workpiece.

Another aspect is a divider insert feed system, comprising: a drive roller (50) capable of displacing paper; at least one of an upper shear blade (100) or a lower shear blade (90) that is positioned downstream of said drive roller (50), said upper shear blade (100) and said lower shear blade (90) capable of cutting a length of paper to form a divider insert (230); an air knife (120) that is capable of displacing the divider insert (230) to a cutting position (500); a slicing blade (20) disposed upwardly from said divider insert (230), said slicing blade (20) capable of descending and pushing said divider insert (230) downwardly to position said divider insert (230) into position into a workpiece; said air knife (120) is disposed downwardly from said slicing blade (20); said air knife (120) has an air gap (240) of 0.002 inches; said air knife (120) has a vacuum chamber (110) defined by a top wall (300) and a bottom wall (310); said air knife (120) having a first wall (267) and said bottom wall (310) that are integral with a radius (270); said radius is about 0.25 inches; said air knife has an air chamber inlet (260) disposed downwardly from said air gap (240), whereby air can flow from said air chamber inlet (260) to said air gap (240); a first air flow (250) starting in the air gap (240) and displacing downstream through said vacuum chamber (110); a second air flow (255) extending from a suction point (280) downstream to said first air flow (250).

Another aspect is a method of displacing divider inserts between adjacent pieces of a food item, comprising the steps of: providing (600) a divider insert roll; displacing (610) a portion of the divider insert roll adjacent a shear blade; cutting (620) a portion of said divider insert roll to form a divider insert (230); displacing (630) said divider insert (230) through an air knife (120) to be positioned downwardly from a slicing blade; and displacing (640) said divider insert (230) downwardly between two adjacent pieces of food.

These and other features, aspects and advantages of the present invention will become better understood with reference to the following drawings, description and claims.

### BRIEF DESCRIPTION OF THE DRAWINGS

FIG. 1 illustrates one pictorial of an embodiment of the present invention;

FIG. 2 illustrates a pictorial of an embodiment of the present invention;

FIG. 3 illustrates a sectional view of the air knife of detail B of FIG. 1; and

FIG. 4 illustrates a method of displacing a divider insert between respective portions of a food product.

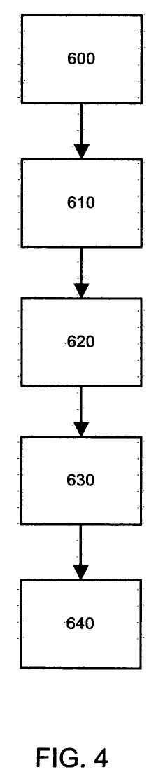

### DETAILED DESCRIPTION OF THE INVENTION

### Reference Numerals

10 DIVIDER INSERT FEED SYSTEM
20 SLICING BLADE
30 DIVIDER INSERT ROLL
40 DIVIDER INSERT PATH
50 DIVE ROLLER
60 PINCH ROLLER
70 PINCH ROLLER RELEASE
80 SHEAR ACTUATOR
90 LOWER SHEAR BLADE
100 UPPER SHEAR BLADE
110 VACUUM CHAMBER
120 AIR KNIFE
130 DIVIDER INSERT FOLD CREASE
140 DIVIDER PRESENT SENSOR
150 DIVIDER ADJUSTABLE STOP
160 DIVIDER FOLD STOP
170 DIVIDER INSERT FEED ROLLER
180 DIVIDER INSERT STOP AND FEEDER
190 CAM ROLLER
200 FOLD CREASE CAM
210 INSERT SCALE
220 GUIDE ROLLER
230 DIVIDER INSERT
240 AIR GAP
250 FIRST AIR FLOW
255 SECOND AIR FLOW
260 AIR CHAMBER INLET
265 CHAMBER SPACE
267 FIRST WALL
270 RADIUS
275 SECOND WALL
280 SUCTION POINT
295 AIR EXIT PORTION
300 TOP WALL
310 BOTTOM WALL
500 CUTTING POSITION
600 PROVIDING A DIVIDER INSERT ROLL
610 DISPLACING A PORTION OF THE DIVIDER INSERT ROLL
620 CUTTING
630 DISPLACING SAID DIVIDER INSERT THROUGH AN AIR KNIFE
640 DISPLACING SAID DIVIDER INSERT DOWNWARDLY

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention may be used to cut paper from a roll to form divider inserts, and position the divider inserts between adjacent foot items.

The present invention differs from the prior art by, among other things, the use of an air knife to displace the cut divider inserts at a high rate of speed. The use of an air knife allows the procedure to be accomplished with less moving parts than a comparable machine with mechanical parts in lieu of the air knife.

Also, the present invention may use a roll of paper, or a set of paper rolls, from which paper is displaced before being cut, then repositioned by means of an air knife to a location under an ultrasonic or mechanical slicing blade, which descends downwardly to reposition the insert.

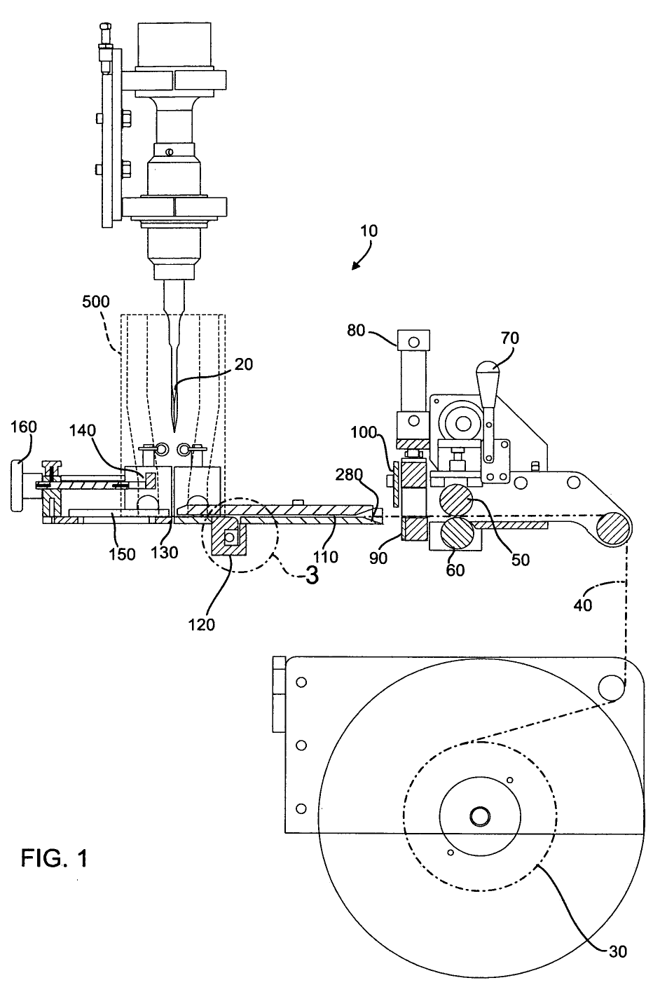

FIG. 1 is a sectional view of one embodiment of the present invention 10. A divider insert roll 30 may be capable of receiving a roll of paper thereon. A guide roller 220 may be disposed to define a divider insert path 40 for the paper. A drive roller 50 may operatively engage a pinch roller 60 to displace paper between the drive roller 50 and the pinch roller 60 toward a cutting member, such as an upper shear blade 100 and a lower shear blade 90. When paper is between the upper shear blade 100 and the lower shear blade 90, the blades 100, 90 may be actuated to cut the paper off of the roll at a desired length. In many applications, divider inserts may range from 2 inches to 7 inches.

An air knife 120 may displace the cut paper, also referred to herein as a divider insert 230 through a vacuum chamber to a divider adjustable stop 150. In one exemplary embodiment of the present invention, the vacuum chamber 110 may be defined by a top wall 300 and bottom wall 310 of the air knife. In one exemplary embodiment, the distance from the top wall 300 to the bottom wall 310 may be about 0.002 inches. In another embodiment, the distance from the top wall 300 to the bottom wall 310 may be greater than 0.002 inches, or less than 0.002 inches. In one embodiment the distance between the top wall 300 and the bottom wall 310 may be about 0.001 inches. In another embodiment, the distance between the top wall 300 and the bottom wall 310 may be about 0.004 inches.

The divider adjustable stop 150 may enable the cut paper 230 to stop mid-way above a divider insert fold crease forming edge 130, and below an ultrasonic or mechanical slicing blade 20. The divider present sensor 140 may sense the position of the cut paper 230, to activate the ultrasonic or mechanical slicing blade 20, also referred to herein as a slicing blade 20. When activated, the slicing blade 20 descends, and moves the cut paper 230, also referred to herein as a divider insert 230, downwardly, to be positioned, generally between two adjacent pieces of food, such as cake slices, which are disposed below the divider insert fold crease forming edge 130. The general operation of the slicing blade 20 is described in U.S. Pat. Nos. 6,662,529, and 6,860,091, both assigned to Foodtools, Inc.

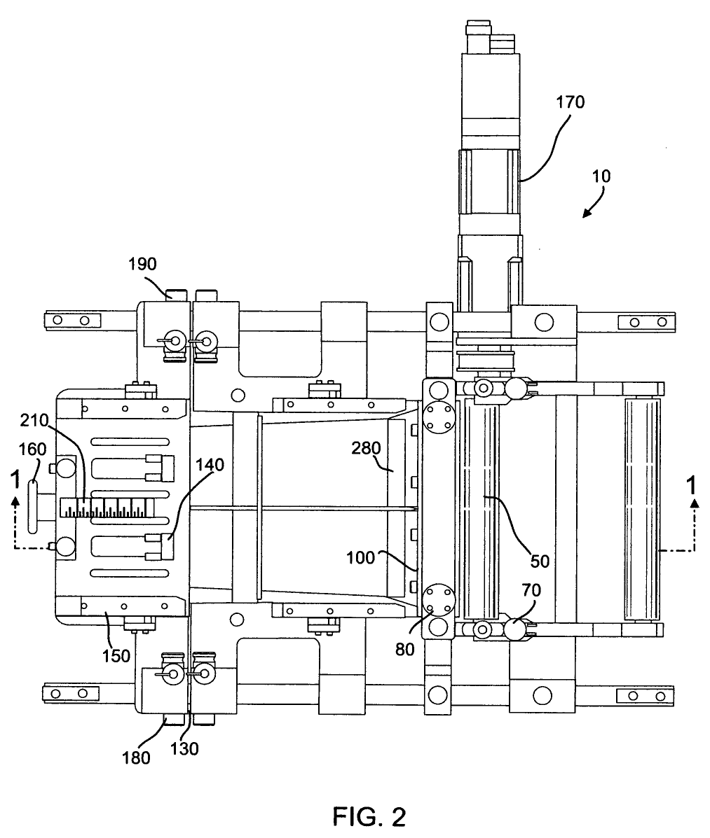

FIG. 2 illustrates a top view of one embodiment of the present invention 10. A divider insert feed roller servo motor is shown at 170, also referred to herein as a motor 170. The motor 170 may be operatively connected to drive the divider insert roll 30.

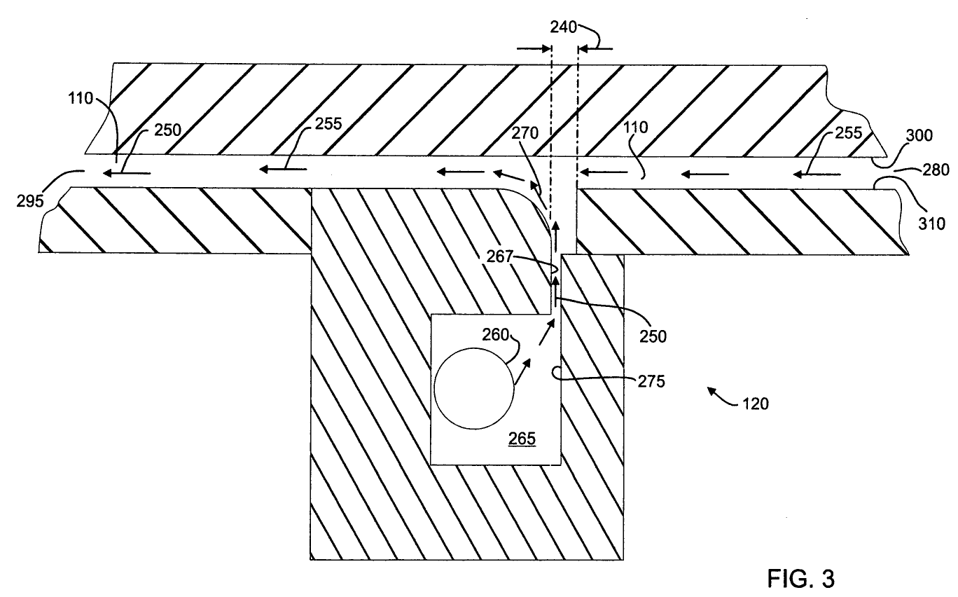

FIG. 3 illustrates an air knife 120 in larger view of detail B of FIG. 1. The air knife 120 may have a chamber space 265 therein to receive air. In one exemplary embodiment, the chamber space 265 may have an air chamber inlet 260, which may displace air into the air knife 120. The air may be displaced in such a way as to follow a first air flow 250 from the air chamber inlet 260, upwardly through an air gap 240, and then through a conduit also referred to herein as a vacuum chamber 110. The air knife 120 may have an air gap 240 that is defined by a first wall 267 and a second wall 275. In one exemplary embodiment of the present invention, the air gap 240 may be 0.002 inches. In a further embodiment, the air gap may be greater than or less than 0.002 inches. A radius 270 may be disposed tangent to the first wall 267 and a surface of the conduit 110 so the air may flow from the chamber space 265, adjacent to the radius 270 and through the conduit or vacuum chamber 110. In one exemplary embodiment the radius 270 is about 0.250 inches. The first air flow 250 may cause a displacement of air, herein referred to as a second air flow 255 from a suction point 280 through the vacuum chamber or conduit 110 in the same direction as the first air flow 250. The first air flow 250 and second air flow 255 may cause the divider insert 230 to move from the suction point 280, leftwardly (in this FIG. 3) to its proper location under the slicing blade 20 to be displaced downwardly into the food item.

In operation, in one embodiment of the present invention, the divider insert feed system 10 is fed from divider insert roll 30 and is guided over a roller 220 into a set of pinch rollers 60 one of which may be driven. The pinch rollers 60 may be driven by a servo motor (not illustrated) to determine the exact length of the individual divider insert 230. Once the length has been fed through the pinch rollers 60 into the vacuum chamber 110, also referred to herein as the pneumatic conveying chamber 110 and has stopped, a mechanical shear, which may comprise an upper shear blade 100 and a lower shear blade 90, is activated and cuts the paper to the proper sized divider insert 230.

A linear venturi 120 or air knife 120 creates a vacuum on the entrance 280, also referred to herein as a suction point 280, of the pneumatic conveying chamber 110. When the paper is cut to form the divider insert 230, the vacuum 255, also referred to herein as the second air flow 255 moves the divider insert 230 horizontally (leftwardly in this FIG. 3) to the venturi 120 and then air pressure or displaced air moves the divider insert 230 the rest of the way to position the divider insert 230 exactly half way under the slicing/insertion blade 20 up against the adjustable divider fold stop 150 to center the divider insert 230. Once the divider insert 230 is in place, the divider insert present sensors 140 are activated and the air pressure is turned off.

At this point, the slicing blade 20 begins to travel downwardly. At the point where the slicing blade 20 contacts the divider insert 230, the divider insert 230 begins to fold around the blade 20 and between the divider insert fold crease forming edges 130 as it moves downward.

As the slicing blade 20 descends, the divider insert fold crease cam 200 contacts the divider insert fold crease cam rollers 190 and the divider insert fold crease forming edges 130 open to allow the blade 20 to pass through without contacting any other components.

The slicing blade 20 may continue downwardly with the divider insert 230 wrapped around it and the slicing blade 20 cuts the product and inserts the divider insert 230 all in the same motion. When the slicing blade 20 reaches the bottom it reverses and moves up, as the divider insert 230 may remain in the position it was placed when the slicing blade 20 reached the bottom. The slicing blade 20 then may move upwardly to the starting position where the reciprocating vertical (slicing blade 20 reciprocating from starting position to the bottom position) cycle is repeated as many times as needed.

In one exemplary embodiment of the present invention 10, the pneumatic conveying chamber 110 or vacuum chamber 110 may be 14.5 inches in length, as measured from the suction point 280 to the air exit portion 295; and may be 12.5 inches in width (as measured perpendicular with respect to the length). In one exemplary embodiment of the present invention 10, the vacuum chamber 110 may be capable of displacing a divider insert 230 that may have a length between 2 inches and 12 inches, and a width between 2 inches and 6 inches. In another embodiment, the vacuum chamber 110 may be 14.5 inches in width, and may be 12.5 inches in length. In one exemplary embodiment of the present invention, the vacuum chamber 110 may have an opening

In one exemplary embodiment of the present invention, the air knife 120 may be made of stainless steel.

The force, flow, and compressed air consumption may be controlled by a pressure regulator with filter. In one exemplary embodiment, a compressed air supply may be on one side of the air knife 120.

The air knife may have a 0.002 inch opening to allow a precise air flow to move the divider insert 230 horizontally from the suction point 280 across the venture and air knife 120 to the adjustable divider fold stop 150.

The air supply may be from 10 pound-force per square inch gauge (PSIG) to 100 PSIG and the air consumption may be from 1 to 4 square cubic feet per minute (SCFM) based on a 12 inch wide air knife 120. The velocity of the second air flow 255 may be from 2000 feet per minute to 13,000 feet per minute at 6 inches from the adjustable divider fold stop 150 based on a 12 inch air knife 120. In one exemplary embodiment of the present invention, the downward velocity of the slicing blade 20 may be from 2000 feet per minute to 13,000 feet per minute.

In one exemplary embodiment of the present invention, a compressor or other air supply may force air into the chamber space 265 or into the air chamber inlet 260, to then be displaced as the first air flow 250, which in turn causes the second air flow 255.

It should be understood, of course, that the foregoing relates to exemplary embodiments of the invention and that modifications may be made without departing from the spirit and scope of the invention as set forth in the following claims.

We claim:

1. A divider insert feed system, comprising:
a drive roller (50) capable of displacing paper;
at least one of an upper shear blade (100) or a lower shear blade (90) that is positioned downstream of said drive roller (50), said upper shear blade (100) and said lower shear blade (90) capable of cutting a length of paper to form a divider insert (230);
an air knife (120) that is capable of displacing the divider insert (230) to a cutting position (500); and
a slicing blade (20) disposed upwardly from said divider insert (230), said slicing blade (20) capable of descending and pushing said divider insert (230) downwardly to position said divider insert (230) into position into a workpiece.

2. The apparatus of claim 1, wherein said slicing blade (20) is an ultrasonic slicing blade (20).

3. The apparatus of claim 1, wherein said slicing blade (20) is a mechanical slicing blade (20).

4. The apparatus of claim 1, wherein said air knife (120) is disposed downwardly from said slicing blade (20).

5. The apparatus of claim 1, wherein said air knife (120) has an air gap (240) of about 0.002 inches.

6. The apparatus of claim 1, further comprising at least one divider insert roll (30).

7. The apparatus of claim 1, further comprising at least one divider insert path (40), whereby multiple divider insert rolls (30) may be used simultaneously, and multiple slicing blades (20) may be respectively used simultaneously.

8. The apparatus of claim 1, wherein said air knife (120) has a vacuum chamber (110) defined by a top wall (300) and a bottom wall (310).

9. The apparatus of claim 1, wherein a first wall (267) and a bottom wall (310) are integral with a radius (270).

10. The apparatus of claim 9, wherein said radius is about 0.25 inches.

11. The apparatus of claim 1, wherein an air chamber inlet (260) is disposed downwardly from an air gap (240), whereby air can flow from said air chamber inlet (260) to said air gap (240).

12. The apparatus of claim 1, further comprising a first air flow (250) starting in the air gap (240) and displacing downstream through a vacuum chamber (110).

13. The apparatus of claim 12, further comprising a second air flow (255) extending from a suction point (280) downstream to the first air flow (250).

14. The apparatus of claim 8, wherein the top wall (300) is separated from said bottom wall (310) by a distance of about 0.002 inches.

15. The apparatus of claim 8, wherein the top wall (300) is separated from said bottom wall (310) by a distance of greater than 0.002 inches.

16. The apparatus of claim 8, wherein the top wall (300) is separated from bottom wall (310) by a distance of less than 0.002 inches.

17. A divider insert feed system, comprising:
a drive roller (50) capable of displacing paper;
at least one of an upper shear blade (100) or a lower shear blade (90) that is positioned downstream of said drive roller (50), said upper shear blade (100) and said lower shear blade (90) capable of cutting a length of paper to form a divider insert (230);
an air knife (120) that is capable of displacing the divider insert (230) to a cutting position (500);
a slicing blade (20) disposed upwardly from said divider insert (230), said slicing blade (20) capable of descending and pushing said divider insert (230) downwardly to position said divider insert (230) into position into a workpiece;
said air knife (120) is disposed downwardly from said slicing blade (20);
said air knife (120) has an air gap (240) of 0.002 inches;
said air knife (120) has a vacuum chamber (110) defined by a top wall (300) and a bottom wall (310);
said air knife (120) having a first wall (267) and said bottom wall (310) that are integral with a radius (270);
said radius is about 0.25 inches;
said air knife has an air chamber inlet (260) disposed downwardly from
said air gap (240), whereby air can flow from said air chamber inlet (260) to said air gap (240);
a first air flow (250) starting in the air gap (240) and displacing downstream through said vacuum chamber (110); and
a second air flow (255) extending from a suction point (280) downstream to said first air flow (250).

18. A method of displacing divider inserts between adjacent pieces of a food item, comprising the steps of:
providing (600) a divider insert roll;
displacing (610) a portion of the divider insert roll adjacent a shear blade;
cutting (620) a portion of said divider insert roll to form a divider insert (230);
displacing (630) said divider insert (230) through an air knife (120) to be positioned downwardly from a slicing blade; and
displacing (640) said divider insert (230) downwardly between two adjacent pieces of food.
